(19) United States
(12) Patent Application Publication
(10) Pub. No.: US 2013/0154895 A1
(43) Pub. Date: Jun. 20, 2013

(54) INTEGRATED ANTENNA STRUCTURE

(71) Applicants: Alireza Mahanfar, Redmond, WA (US); Carlos Manzanedo, Kirkland, WA (US); Jagdeep Singh Toor, Redmond, WA (US); Vinod L. Hingorani, Redmond, WA (US); Louis C. Barinaga, Snohomish, WA (US)

(72) Inventors: Alireza Mahanfar, Redmond, WA (US); Carlos Manzanedo, Kirkland, WA (US); Jagdeep Singh Toor, Redmond, WA (US); Vinod L. Hingorani, Redmond, WA (US); Louis C. Barinaga, Snohomish, WA (US)

(73) Assignee: MICROSOFT CORPORATION, Redmond, WA (US)

(21) Appl. No.: 13/330,401

(22) Filed: Dec. 19, 2011

(51) Int. Cl. H01Q 1/50; H01Q 1/38

(52) U.S. Cl. 343/860; 343/700 MS

(57) ABSTRACT

Techniques for implementing an integrated antenna structure are described. In at least some embodiments, the integrated antenna structure includes an antenna that is folded and/or meandered in design to enable the antenna to be incorporated into a compact area. The integrated antenna structure further includes a printed circuit board (PCB) with a ground plane to which the antenna is connected. In implementations, the antenna and the PCB can be combined to form an integrated radiating structure that can be incorporated into a device to enable the device to transmit and/or receive wireless signals.

### BACKGROUND

Many devices today utilize some form of wireless technology to transmit and receive information. Such devices typically include an antenna that enables wireless signals to be transmitted and received. Designing a suitable antenna for a device can present a number of challenges. For example, the size of an antenna can affect the overall form factor of a device. Further, the durability of antenna can be affected by the way in which the antenna is incorporated into a device.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Techniques for implementing an integrated antenna structure are described. In at least some embodiments, the integrated antenna structure includes an antenna that is folded and/or meandered in design to enable the antenna to be incorporated into a compact area. The integrated antenna structure further includes a printed circuit board (PCB) with a ground plane to which the antenna is connected. In implementations, the antenna and the PCB can be combined to form an integrated radiating structure that can be incorporated into a device to enable the device to send and/or receive wireless signals.

In at least some embodiments, the integrated antenna structure can be operably attached to a radio transmitter and/or receiver of a device via an impedance matching functionality that can optimize the signal reception and/or transmission performance of the integrated antenna structure. Examples of such impedance matching functionalities include transformers, resisters, inductors, capacitors, transmission lines, and/or combinations thereof.

In at least some embodiments, an antenna carrier can be utilized to attach the antenna to the PCB to form the integrated antenna structure. In implementations, the antenna carrier is a structure to which the antenna can be attached prior to the antenna being attached to the PCB. The antenna carrier can serve as a transport mechanism for the antenna to enable the antenna to be moved between various locations without being damaged. For example, the antenna can be attached to the antenna carrier, and the antenna carrier can be manipulated by manufacturing machinery onto the PCB without the machinery contacting the antenna itself.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ techniques discussed herein.

FIG. 2 illustrates an example antenna in accordance with one or more embodiments.

FIG. 3 illustrates a detailed example of an antenna in accordance with one or more embodiments.

FIG. 4 illustrates a detailed example of a printed circuit board in accordance with one or more embodiments.

FIG. 5 illustrates an example antenna carrier in accordance with one or more embodiments.

FIG. 6 illustrates an example implementation scenario in accordance with one or more embodiments.

FIG. 7 illustrates various components of an example device that can be implemented as any type of portable and/or computer device as described with reference to FIG. 1 to implement embodiments of the techniques described herein.

### DETAILED DESCRIPTION

### Overview

Techniques for implementing an integrated antenna structure are described. In at least some embodiments, the integrated antenna structure includes an antenna that is folded and/or meandered in design to enable the antenna to be incorporated into a compact area. The integrated antenna structure further includes a printed circuit board (PCB) with a ground plane to which the antenna is connected. In implementations, the antenna and the PCB can be combined to form an integrated radiating structure that can be incorporated into a device to enable the device to send and/or receive wireless signals.

In at least some embodiments, the integrated antenna structure can be operably attached to a radio transmitter and/or receiver of a device via an impedance matching functionality that can optimize the signal reception and/or transmission performance of the integrated antenna structure. Examples of such impedance matching functionalities include transformers, inductors, capacitors, transmission lines, and/or combinations thereof.

In at least some embodiments, an antenna carrier can be utilized to attach the antenna to the PCB to form the integrated antenna structure. In implementations, the antenna carrier is a structure to which the antenna can be attached prior to the antenna being attached to the PCB. The antenna carrier can serve as a transport mechanism for the antenna to enable the antenna to be moved between various locations without being damaged. For example, the antenna can be attached to the antenna carrier, and the antenna carrier can be manipulated onto the PCB by manufacturing machinery without the machinery contacting the antenna itself.

In the following discussion, an example environment is first described that is operable to employ techniques for implementing integrated antenna structures described herein. Next, a section entitled “Integrated Antenna Structure” describes some example aspects of integrated antenna structures in accordance with one or more embodiments. Following this, a section entitled “Antenna Carrier” describes example embodiments of an antenna carrier. Finally, an example device is described that is operable to employ techniques discussed herein in accordance with one or more embodiments.

Example Environment

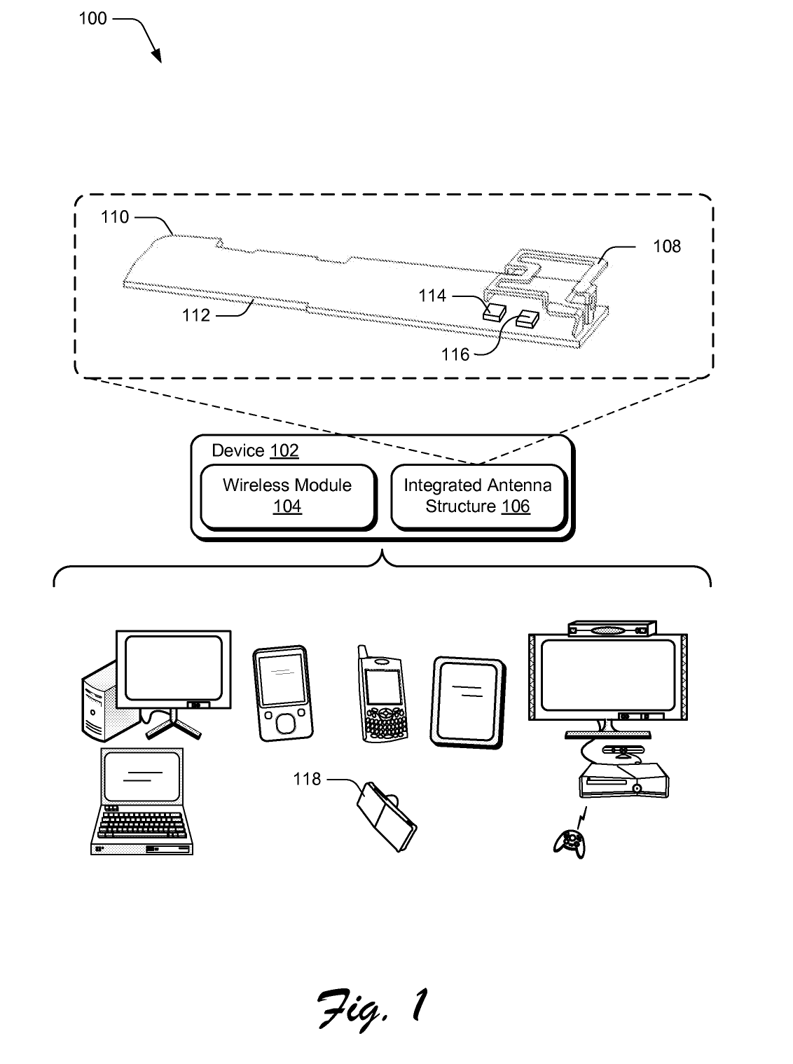

FIG. 1 is an illustration of an environment 100 in an example implementation that is operable to employ techniques for implementing an integrated antenna structure. Environment 100 includes a device 102 having a wireless module 104 and an integrated antenna structure 106. The wireless module 104 is representative of functionality to enable the device 102 to communicate using various wireless techniques and/or protocols. Examples of such techniques and/or protocols include the 802.11 protocols, Bluetooth, cellular communications (e.g., cell phones), radio communications, and so on.

Included as part of the integrated antenna structure 106 is an antenna 108 that is attached to a printed circuit board (PCB) 110. In implementations, the antenna 108 is formed out of metallic and/or electrically conductive material that can transmit and/or receive wireless signals. For example, the antenna can be formed as a wire trace design that can conform to various configurations discussed herein. Further examples and implementations of the antenna 108 are discussed in more detail below.

The PCB 110 is representative of a structure that is used to mechanically support and electrically connect electronic components of the device 102. For example, the PCB 110 can connect various components of the device 102 using conductive pathways, tracks, signal traces, and so on, etched from sheets of electrically conductive material (e.g., copper) laminated onto a non-conductive substrate. Included as part of the PCB 110 is a ground plane 112, which is representative of a surface and/or layer of the PCB 110 that is formed from electrically conductive material. In implementations, the ground plane 112 can provide an electrical ground connection for various components of the device 102 that connect to the ground plane.

Also illustrated as part of the PCB 110 are a radio 114 and an impedance matcher 116. The radio 114 is representative of functionality (e.g., a hardware device) to transmit and receive wireless signals via the device 102. For example, the radio 114 can generate radio frequency electrical current and apply the electrical current to the antenna 108 and/or the ground plane 112 such that the electrical current can be transmitted as radio waves. In implementations, the wireless module 104 can control and/or communicate with the radio 114 to enable the transmission and reception of wireless signals. For example, the wireless module 104 can receive data to be transmitted from the device 102, and can convert the data into a form that can be used by the radio 114 to generate radio frequency electrical current that represents the data. The radio frequency electrical current can be applied to the antenna 108 and/or the ground plane 112 such that the data is transmitted for receipt by a different device.

The impedance matcher 116 is representative of functionality to perform impedance matching and manipulation for various components of the device 102. For example, the impedance matcher 116 can be situated between an output portion of the radio 114 and an input portion of the antenna 108. In operation, the impedance matcher 116 can operate to match an output impedance of the radio 114 with an input impedance of the antenna 108 to optimize signal reception and transmission performance of the integrated antenna structure 106. The impedance matcher 116 can be implemented using various resisters, inductors, capacitors, transmission lines, and/or combinations thereof. In embodiments, the impedance matcher 116 can include a pi network communicatively connected to various components of the device 102, such as between the antenna 108 and the radio 114.

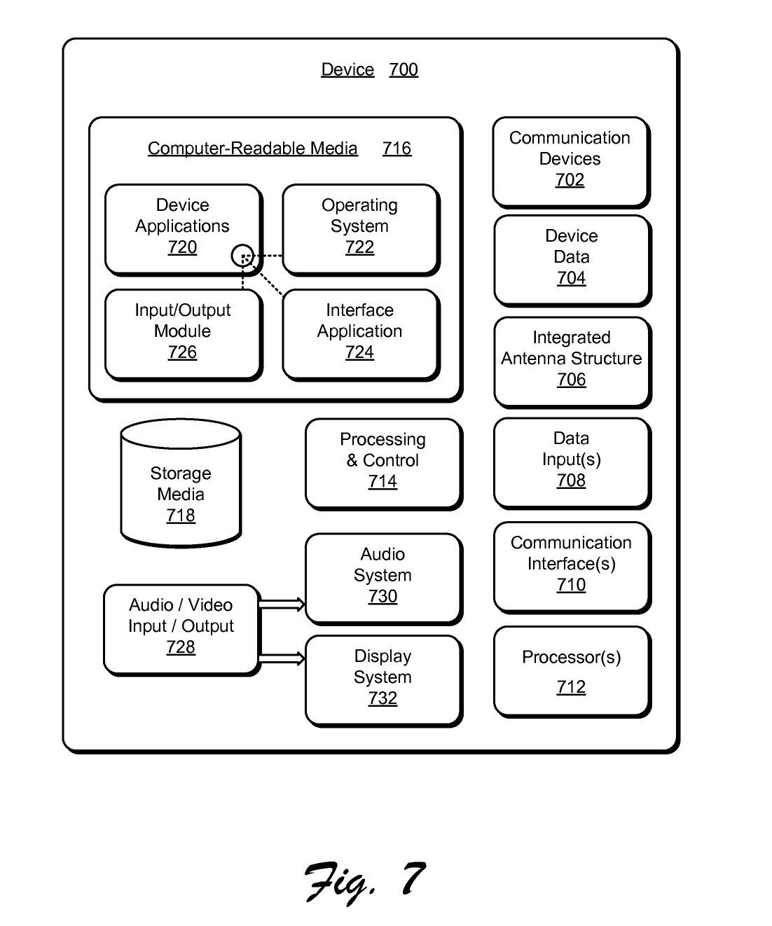

The device 102 can be embodied as any suitable device such as, by way of example and not limitation, a desktop computer, a portable computer, a handheld computer such as a personal digital assistant (PDA), mobile phone, tablet computer, and the like. One example implementation of the device 102 is a wireless headset 118, which can be utilized by a user to communicate with various other devices. For example, the wireless headset 118 can leverage the wireless module 104 and the integrated antenna structure 106 to transmit voice communications from a user to one or more other devices via a wireless network. Further, the wireless headset 118 can receive voice communications from other users received via wireless transmission and audibly output the voice communications to the user. One of a variety of different examples of the device 102 is shown and described below in FIG. 7.

Having described an example environment, consider now a discussion of some example features of an integrated antenna structure in accordance with one or more embodiments.

Integrated Antenna Structure

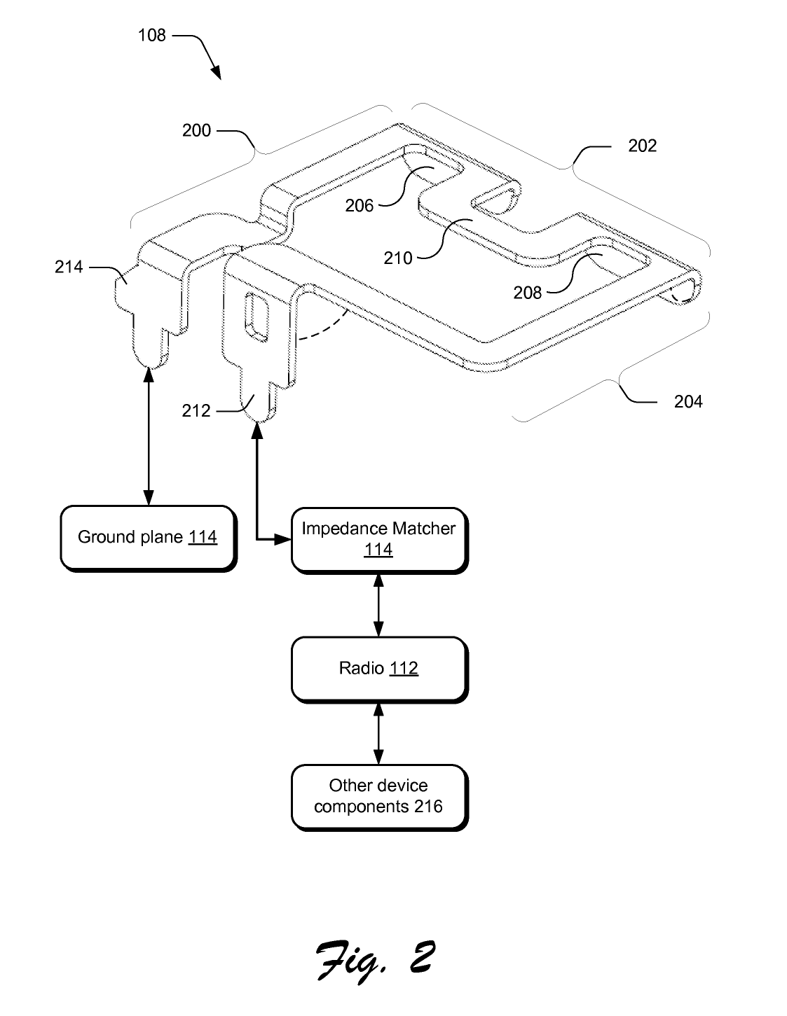

FIG. 2 illustrates a detailed example of the antenna 108, introduced above with reference to environment 100.

The antenna 108 includes a first side portion 200, a front portion 202, and a second side portion 204. The front portion 202 includes a first lip 206 and a second lip 208, which are folded at an angle (e.g., 90 degrees) with respect to a top surface 210 of the antenna 108. Further, the antenna 108 displays a meandered configuration, e.g., is non-linear. For example, the top surface 210 is curved to increase the surface area of the antenna 108, such as indicated by the curving of the top surface 210 displayed between the first lip 206 and the second lip 208

The antenna 108 further includes a feed point 212 and a ground connection 214. The feed point 212 and the ground connection 214 can form a respective first end and second end of the antenna 108 that can be used to attached the antenna to the PCB 110. In implementations, the feed point 212 serves as a connection point for the antenna 108 to components of the device 102, such as the impedance matcher 116, the radio 114, and other device components 216. Examples of the other device components 216 include various components that are discussed above and below with reference to example device 102. In implementations, the impedance matcher 116 can be implemented to match an impedance that can exist between an output of the radio 114 and/or the other device components 216, and an input impedance of the feed point 212.

As illustrated, the ground connection 214 is connected to the ground plane 112. In implementations, this can enable the antenna 108 and the ground plane 112 to serve as an integrated radiating surface that can be utilized to send and/or receive wireless signals.

Thus, as indicated in this example, the antenna 108 includes a folded and meandered design that enables the antenna to fit more antenna surface in a smaller space than do typical loop-style antennas.

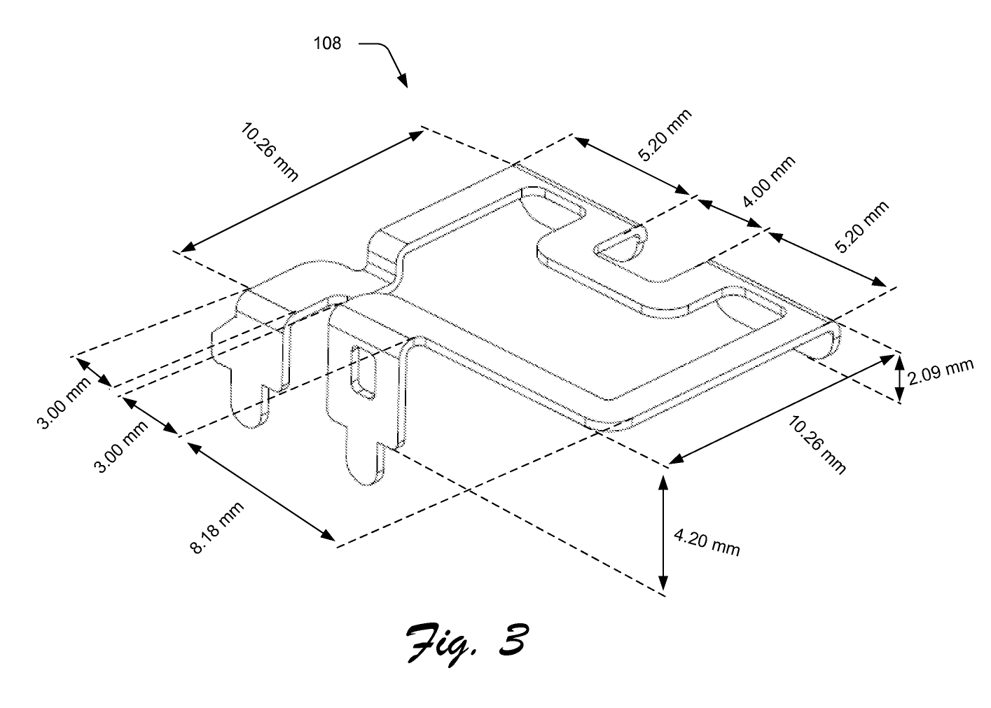

FIG. 3 illustrates a detailed example of the antenna 108, and includes example dimensions for various portions of the antenna. The example dimensions are indicated in units of millimeter (mm) and are provided to illustrate but one example implementation of the antenna 108. Accordingly, it is to be appreciated that the antenna 108 may be implemented according to a variety of different configurations and dimensions while remaining within the spirit and scope of the claimed embodiments.

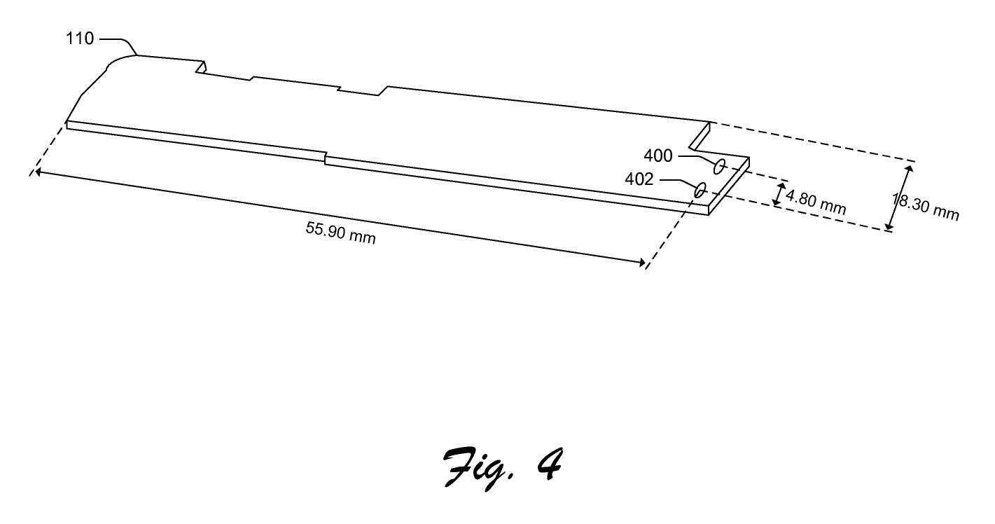

FIG. 4 illustrates a detailed example of the PCB 110, and includes example dimensions for several portions of the PCB. The example dimensions are indicated in units of millimeter (mm) and are provided to illustrate but one example implementation of the PCB 110. Accordingly, it is to be appreciated that the PCB 110 may be implemented according to a variety of different configurations and dimensions while remaining within the spirit and scope of the claimed embodiments.

Further illustrated as part of the PCB 110 are a feed connection point 400 and a ground connection point 402. In implementations, the feed connection point 400 is operatively connected to various components of the PCB 110, such as the radio 114, the impedance matcher 116, the other device components 216, and so on. The feed connection point 400 can be connected to these components via conductive pathways, tracks, signal traces, and so on, included as part of the PCB 110. Thus, connection of the feed point 212 of the antenna 108 to the feed connection point 400 can serve to connect the antenna 108 to various components of the PCB 110.

The ground connection point 402 can be connected to a ground structure of the PCB 110, such as the ground plane 112. Accordingly, connection of the ground connection 214 of the antenna 108 to the ground connection point 402 can serve to connect the antenna 108 to the ground structure.

In implementations, the example antenna 108 described in FIG. 3 and the example PCB 110 described in FIG. 4 can be operatively connected to provide an integrated antenna structure that can operate in the 2400-2500 Megahertz (MHz) radio spectrum. For instance, using the example dimensions indicated for the antenna 108 and the PCB 110, the antenna and the PCB can be combined to form an integrated radiating structure that can transmit and receive signals in the 2400-2500 MHz range. It is to be appreciated, however, that in at least some embodiments the antenna 108 and PCB 110 can be implemented according to a variety of different configurations and/or dimensions in order to provide functionality in a variety of different wireless signal frequency ranges. For example, changing one or more dimensions of the antenna 108 and/or the PCB 110 can enable an integrated antenna structure to send and/or receive wireless signals in various different wireless signal frequency ranges. It is to be further appreciated that such embodiments are considered to be within the spirit and scope of the embodiments claimed herein.

Antenna Carrier

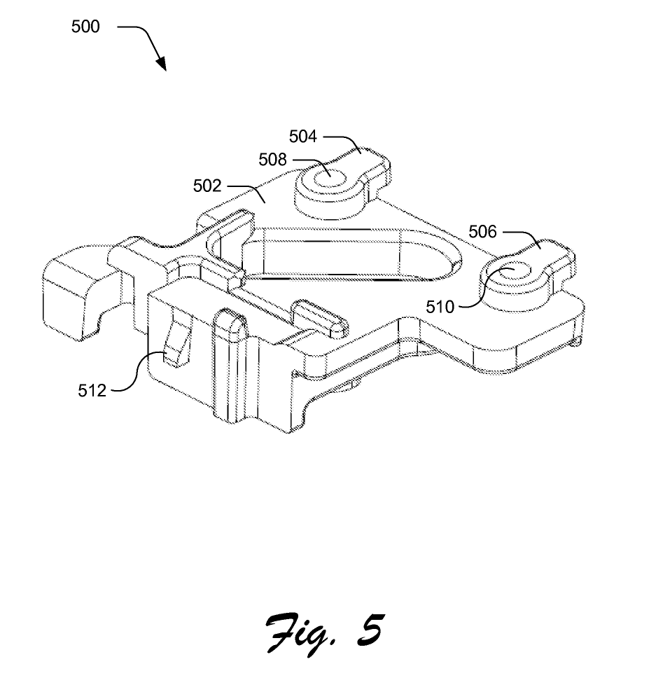

FIG. 5 illustrates an example antenna carrier in accordance with one or more embodiments, generally at 500. In implementations, the antenna 108 (discussed above and below) can be attached to the antenna carrier 500 to enable the antenna 108 to be manipulated, such as during an assembly and/or manufacturing process.

The antenna carrier 500 includes a top surface 502 upon which the antenna 108 can be placed. As part of the top surface 502 are a first projection 504 and a second projection 506. The first projection 504 and the second projection 506 extend outward from the front of the antenna carrier 500 and can function as a portion of a fastening mechanism for fastening the antenna 108 to the antenna carrier 500.

Situated within the first projection 504 is a first cavity 508, and within the second projection 506 is a second cavity 510. In implementations, the first cavity 508 and/or the second cavity 510 can function as a grip or attachment point for various assembly or manufacturing machinery.

The antenna carrier 500 further includes a catch point 512, which protrudes from the rear surface of the antenna carrier 500 and can function as an attachment point for a portion of the antenna 108. An example attachment of an antenna to the antenna carrier 500 is discussed below.

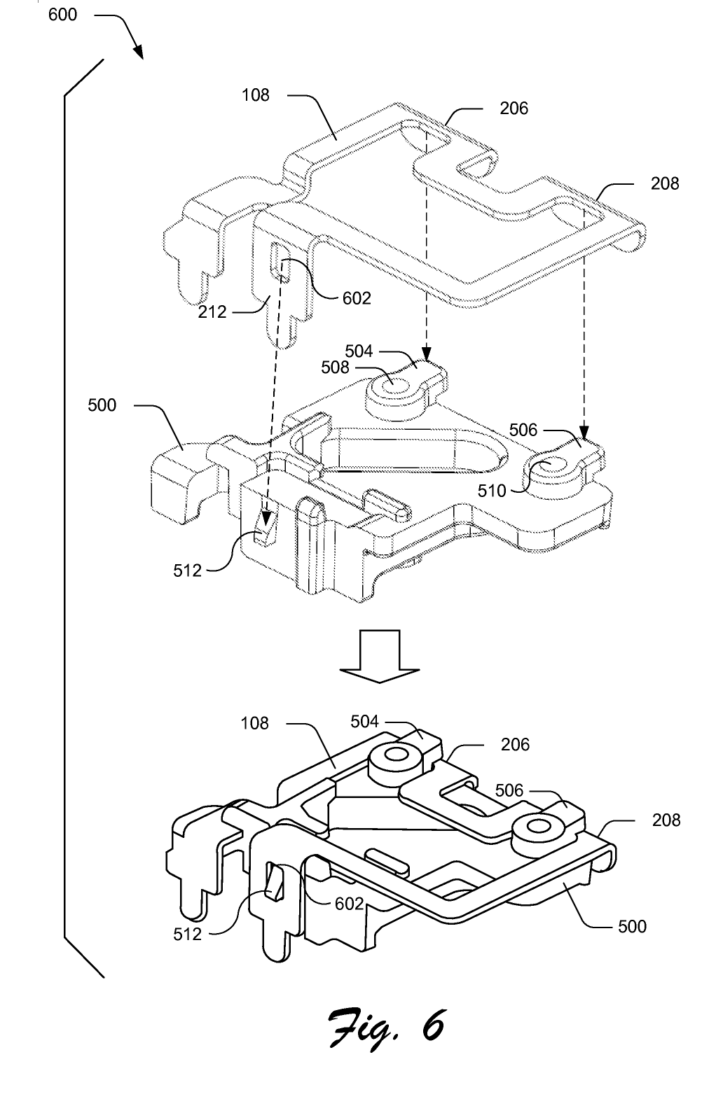

FIG. 6 illustrates an example implementation scenario 600 in accordance with one or more embodiments. In the upper portion of the implementation scenario 600 are illustrated the antenna 108 and the antenna carrier 500. To attach the antenna 108 to the antenna carrier 500, the first lip 206 of the antenna 108 is placed around the first projection 504, and the second lip 208 is placed around the second projection 506. The feed point 212 of the antenna 108 is placed along the rear surface of the antenna carrier 500 such that the catch point 512 catches within a perforation 602 in the feed point 212.

Continuing to the lower portion of the implementation scenario 600, the first lip 206 is illustrated as being situated underneath the first projection 504, and the second lip 208 is situated underneath the second projection 506. Further, the catch point 512 is illustrated as protruding through the perforation 602 such that the feed point 212 catches on the rear surface of the antenna carrier 500. Thus, in implementations the antenna 108 can function as a “spring clip” that can snap on to the antenna carrier 500.

By attaching the antenna 108 to the antenna carrier 500, the antenna 108 can be manipulated by machinery during an assembly and/or manufacturing process without the machinery coming in contact with the antenna 108 itself. For example, machinery can grasp the antenna carrier 500 via one or more of the first projection 504, the cavity first 508, the second projection 506, and/or the second cavity 510. The machinery can place antenna carrier 500 and the attached antenna 108 onto the PCB 110. The antenna carrier 500 can be attached to the PCB 110, such as using a suitable adhesive or other attachment mechanism. The antenna 108 can also be fastened to the PCB 110, such as via a variety of different soldering techniques. When attached to the PCB 110, the antenna carrier 500 can function as a stabilizer for the antenna 108 to increase the resistance of the antenna to damage that may occur as a result of an impact or shock event.

Having described an example antenna carrier, consider now a discussion of an example device in accordance with one or more embodiments.

Example Device

FIG. 7 illustrates various components of an example device 700 that can be implemented as any type of device 102 as described with reference to FIG. 1 to implement embodiments of the techniques described herein. Device 700 includes communication devices 702 that enable wired and/or wireless communication of device data 704 (e.g., received data, data that is being received, data scheduled for broadcast, data packets of the data, etc.). In implementations, the communication devices 702 can enable wireless communication via an integrated antenna structure 706, examples of which are described above.

The device data 704 or other device content can include configuration settings of the device, media content stored on the device, and/or information associated with a user of the device. Media content stored on device 700 can include any type of audio, video, and/or image data. Device 700 includes one or more data inputs 708 via which any type of data, media content, and/or inputs can be received, such as user-selectable inputs, messages, music, television media content, recorded video content, and any other type of audio, video, and/or image data received from any content and/or data source.

Device 700 also includes communication interfaces 710 that can be implemented as any one or more of a serial and/or parallel interface, a wireless interface, any type of network interface, a modem, and as any other type of communication interface. The communication interfaces 710 provide a connection and/or communication link between device 700 and a communication network by which other electronic, computing, and communication devices communicate data with device 700.

Device 700 includes one or more processors 712 (e.g., any of microprocessors, controllers, and the like) which process various computer-executable instructions to control the operation of device 700 and to implement embodiments of the techniques described herein. Alternatively or in addition, device 700 can be implemented with any one or combination of hardware, firmware, or fixed logic circuitry that is implemented in connection with processing and control circuits which are generally identified at 714. Although not shown, device 700 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 700 also includes computer-readable media 716, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 700 can also include a mass storage media device 718.

Computer-readable media 716 provides data storage mechanisms to store the device data 704, as well as various device applications 720 and any other types of information and/or data related to operational aspects of device 700. For example, an operating system 722 can be maintained as a computer application with the computer-readable media 716 and executed on processors 712. The device applications 720 can include a device manager (e.g., a control application, software application, signal processing and control module, code that is native to a particular device, a hardware abstraction layer for a particular device, etc.). The device applications 720 also include any system components or modules to implement embodiments of the techniques described herein.

In this example, the device applications 720 include an interface application 724 and an input/output module 726 that are shown as software modules and/or computer applications. The input/output module 726 is representative of software that is used to provide an interface with a device configured to capture inputs, such as a touchscreen, track pad, camera, microphone, and so on. Alternatively or in addition, the interface application 724 and the input/output module 726 can be implemented as hardware, software, firmware, or any combination thereof. Additionally, the input/output module 726 may be configured to support multiple input devices, such as separate devices to capture visual and audio inputs, respectively.

Device 700 also includes an audio and/or video input-output system 728 that provides audio data to an audio system 730 and/or provides video data to a display system 732. The audio system 730 and/or the display system 732 can include any devices that process, display, and/or otherwise render audio, video, and image data. Video signals and audio signals can be communicated from device 700 to an audio device and/or to a display device via an RF (radio frequency) link, S-video link, composite video link, component video link, DVI (digital video interface), analog audio connection, or other similar communication link. In an embodiment, the audio system 730 and/or the display system 732 are implemented as external components to device 700. Alternatively, the audio system 730 and/or the display system 732 are implemented as integrated components of example device 700.

Generally, any of the functions described herein can be implemented using software, firmware, hardware (e.g., fixed logic circuitry), or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on a processor (e.g., CPU or CPUs). The program code can be stored in one or more computer readable memory devices. The features of the techniques described below are platform-independent, meaning that the techniques may be implemented on a variety of commercial computing platforms having a variety of processors.

For example, the computing device 700 may also include an entity (e.g., software) that causes hardware of the device 700 to perform operations, e.g., processors, functional blocks, and so on. For example, the device 700 may include a computer-readable medium that may be configured to maintain instructions that cause the computing device, and more particularly hardware of the device 700 to perform operations. Thus, the instructions function to configure the hardware to perform the operations and in this way result in transformation of the hardware to perform functions. The instructions may be provided by the computer-readable medium to the device 700 through a variety of different configurations.

One such configuration of a computer-readable medium is signal bearing medium and thus is configured to transmit the instructions (e.g., as a carrier wave) to the hardware of the computing device, such as via a network. The computer-readable medium may also be configured as a computer-readable storage medium and thus is not a signal bearing medium or other transitory medium. Examples of a computer-readable storage medium include a random-access memory (RAM), read-only memory (ROM), an optical disc, flash memory, hard disk memory, and other memory devices that may use magnetic, optical, and other techniques to store instructions and other data.

### CONCLUSION

Techniques for implementing an integrated antenna structure are described. Although embodiments are described in language specific to structural features and/or methodological acts, it is to be understood that the embodiments defined in the appended claims are not necessarily limited to the specific features or acts described. Rather, the specific features and acts are disclosed as example forms of implementing the claimed embodiments.

What is claimed is:

1. A wireless headset device comprising:
a wireless module configured to manage wireless data communication for the wireless headset device; and
an integrated antenna structure operably associated with the wireless module and configured to transmit and receive wireless signals as part of the wireless data communication, the integrated antenna structure including:
a printed circuit board (PCB) including a ground plane; and
an antenna attached to the PCB and connected to the ground plane such that the antenna and the ground plane are configured to combine to transmit and receive the wireless signals.

2. The wireless headset device as recited in claim 1, wherein the antenna and the ground plane combine to form an integrated radiating structure configured to transmit and receive the wireless signals by performing one or more of transmitting radio waves or receiving radio waves.

3. The wireless headset device as recited in claim 1, wherein structural dimensions of the ground plane and the antenna are such that the integrated antenna structure can send and receive wireless signals in at least the range of 2400 megahertz to 2500 megahertz.

4. The wireless headset device as recited in claim 1, further comprising a radio device configured to generate radio frequency electrical current and communicate the radio frequency electrical current to the integrated antenna structure such that the radio frequency electrical current can be transmitted as the wireless signals.

5. The wireless headset device as recited in claim 4, further comprising an impedance matching device connected to the radio device and the integrated antenna structure and configured to match an output impedance of the radio device to an input impedance of the integrated antenna structure.

6. The wireless headset device as recited in claim 1, further comprising an antenna carrier configured to have the antenna attached thereto such that the antenna can be attached to the PCB by manufacturing machinery without the manufacturing machinery contacting the antenna.

7. An integrated antenna structure comprising:
a printed circuit board (PCB) including a ground plane; and
an antenna attached to the PCB and connected to the ground plane such that the antenna and the ground plane combine to form an integrated radiating structure configured to transmit and receive wireless signals.

8. The integrated antenna structure as recited in claim 7, wherein the integrated antenna structure comprises a portion of a device that is configured to send and receive data via the wireless signals.

9. The integrated antenna structure as recited in claim 7, wherein structural dimensions of the ground plane and the antenna are such that the integrated antenna structure can transmit and receive wireless signals in at least the range of 2400 megahertz to 2500 megahertz.

10. The integrated antenna structure as recited in claim 7, further comprising a radio device attached to the PCB and configured to generate radio frequency electrical current and communicate the radio frequency electrical current to the antenna such that the radio frequency electrical current can be transmitted by the integrated radiating structure as the wireless signals.

11. The integrated antenna structure as recited in claim 10, further comprising an impedance matching device connected between the radio device and the antenna and configured to match an output impedance of the radio device to an input impedance of the antenna.

12. The integrated antenna structure as recited in claim 11, wherein the antenna is attached to the impedance matching device at a first end of the antenna and to the ground plane at a second end of the antenna.

13. The integrated antenna structure as recited in claim 7, further comprising an antenna carrier configured to have the antenna attached thereto such that the antenna can be manipulated onto the PCB by manufacturing machinery without the manufacturing machinery contacting the antenna.

14. A device comprising:
a printed circuit board (PCB) including a ground structure and a radio device configured to generate radio frequency electrical current;
an antenna attached to the PCB and operably connected to the ground structure and the radio device such that the antenna and the ground structure combine to form an integrated antenna structure configured to receive the radio frequency electrical current from the radio device and transmit the radio frequency electrical current as radio waves; and
an impedance matching device operably connected to the PCB between the radio device and the antenna and configured to match an output impedance of the radio device to an input impedance of the antenna.

15. The device as recited in claim 14, wherein the device comprises a wireless headset device configured to send and receive data via the radio waves.

16. The device as recited in claim 14, wherein structural dimensions of the integrated antenna structure is such that the integrated antenna structure can send and receive wireless signals in at least the range of 2400 megahertz to 2500 megahertz.

17. The device as recited in claim 14, wherein the integrated antenna structure comprises an integrated radiating surface comprised of the antenna and the ground structure.

18. The device as recited in claim 14, wherein the ground structure comprises a ground plane for the PCB.

19. The device as recited in claim 14, wherein the antenna is attached to the impedance matching device at a first end of the antenna and to the ground plane at a second end of the antenna.

20. The device as recited in claim 14, further comprising an antenna carrier configured to have the antenna attached thereto such that the antenna can be manipulated onto the PCB via the antenna carrier by manufacturing machinery without the manufacturing machinery contacting the antenna, the antenna carrier further functioning as a stabilizer for the antenna on the device.
